(19) United States
(12) Patent Application Publication
(10) Pub. No.: US 2009/0054058 A1
(43) Pub. Date: Feb. 26, 2009

(54) SYSTEM AND METHOD FOR SHORT RANGE SHARING OF BANDWIDTH BETWEEN ELECTRONIC EQUIPMENT

(75) Inventors: Markus Andreasson, Lund (SE); Per Astrand, Lund (SE); Erik Backlund, Gantofta (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/843,811

(22) Filed: Aug. 23, 2007

(51) Int. Cl. H04Q 7/20

(52) U.S. Cl. 455/426.1

(57) ABSTRACT

A system and method for a plurality of electronic equipment located within a short range communication zone to share bandwidth with each other. In one aspect of the invention, an electronic equipment (a requesting electronic equipment) transmits a request for content over a cellular telephone network (e.g., 3G, GPRS, etc.). In addition, the electronic equipment communicates with other electronic equipment through a wireless local area network (WLAN) interface (e.g., Bluetooth, 802.11, etc.) to determine if the other electronic equipment are available to share bandwidth with the requesting electronic equipment. The other electronic transmit the requested content to the master portable communication device through the WLAN interface.

### TECHNICAL FIELD OF THE INVENTION

The present invention relates to a system and method for short range sharing of bandwidth between electronic equipment and, more particularly, to a system and method for portable communication devices to share excess bandwidth among other portable communication devices for increasing effective network bandwidth to the portable communication devices.

### DESCRIPTION OF THE RELATED ART

Electronic equipment, such as, for example, portable communication devices, mobile phones, personal digital assistants, etc. are typically equipped to communicate with cellular telephone communication networks, as well as, related network services, e.g., Internet applications, electronic mail applications, global positioning applications, etc. Such electronic equipment is increasingly being equipped with adapters to support advanced communications in a variety of mediums. Such advanced communication mediums may include, for example, Ethernet, Bluetooth, 802.11, wireless local area networks (WLANs), WiFi, WiMax and the like.

It is known for a portable communication device to establish a communication link with a single base station at any particular given time to perform one or more communication tasks. The bandwidth for a communication link between a portable communication device and a base station (e.g., the Internet access bandwidth of the portable communication device) is generally much lower than the total bandwidth of the base station or the collection of base stations that the portable communication device could potentially connect to in its vicinity. There are many reasons for this. For example, the bandwidth of the portable communication device is generally lower than the bandwidth of the base station; the portable communication device can only connect to one base station at a time; the base station may reserve bandwidth to other mobile communication devices; and some base stations may belong to network operators other than the network operator in which the portable communication device subscribes.

Portable communication devices often have other like devices within a short range. The combined bandwidth of the Internet access of other portable communication devices within communication range can be much higher than the bandwidth of a single portable communication device. For example, in crowded areas such as sporting events, shopping malls etc., portable communication devices are ubiquitous. Since many network operators provide data subscriptions based on a flat rate, there is a significant amount of bandwidth that is not fully utilized.

### SUMMARY

In view of the aforementioned shortcomings associated with sharing bandwidth between portable communication devices, there is a need in the art for a method of sharing bandwidth between portable communication devices (e.g., a mobile telephone) and other electronic equipment (e.g., portable communication devices, mobile telephones, computers, laptops, etc.) that provides for efficient use of available bandwidth.

One aspect of the invention relates to a method for sharing bandwidth between a master portable communication device and electronic equipment, the method comprising: transmitting a first request for content stored remotely on a wide area network from a master portable communication device through a wireless wide area network interface to a server and transmitting a second request for access to available bandwidth through a wireless local area network interface of the master portable communication device to one or more electronic equipment, wherein the second request includes information and an address of the server in which the master portable communication device is registered; establishing a communication link between the one or more electronic equipment that is able to provide additional bandwidth for the master portable communication device; and receiving at least a portion of the content at the master portable communication device from the one or more electronic equipment through the communication link established between the one or more electronic equipment and the master portable communication device.

Another aspect of the invention relates to the information transmitted to the one or more electronic devices from the master portable communication device being encrypted.

Another aspect of the invention relates to the server is a proxy server.

Another aspect of the invention includes storing at least a portion of the received content in a memory of the master portable communication device.

Another aspect of the invention includes displaying at least a portion of the received content on display of the master portable communication device.

Another aspect of the invention includes periodically updating the communication link between the one or more electronic equipment and the portable communication device to determine if the one or more electronic equipment are within communication range of the master portable communication device.

Another aspect of the invention relates to the address being an Internet Protocol address of the server.

Another aspect of the invention relates to the wireless local area network interface being a Bluetooth compatible interface.

Another aspect of the invention relates to the wireless local area network interface is a WiFi compatible interface.

Another aspect of the invention includes receiving a second portion of the content from the server through the wireless wide area network.

Another aspect of the invention further includes combining the portions of content received from the one or more electronic equipment and the wide area network and storing the combined contents in memory.

One aspect of the invention relates to a method for a server to deliver content acquired from multiple electronic equipment to a master portable communication device, the method comprising: receiving a request for content from a master portable communication device through a wide area network; receiving data from one or more electronic equipment that are able to assist in downloading the content requested by the master portable communication device; accumulating data received from a remote source that stores the requested content; and transmitting at least a portion of the data to the one or more electronic equipment for transmission to the master portable communication device, wherein the data relates to the requested content.

Another aspect of the invention relates to the data being transmitted from the electronic equipment to the portable communication device through a wireless local area network interface.

Another aspect of the invention relates to the wireless local area network interface being a Bluetooth compatible interface.

Another aspect of the invention relates to the wireless local area network interface being a WiFi compatible interface.

Another aspect of the invention relates to the at least a portion of data being transmitted to the master portable communication device after the requested content is accumulated.

Another aspect of the invention relates to the at least a portion of data being transmitted to the master portable communication device after at least one portion of the requested content is accumulated.

Another aspect of the invention relates to a method for sharing bandwidth between a master portable communication device and electronic equipment, the method comprising: receiving a request for access to available bandwidth through a wireless local area network interface from a master portable communication device, wherein the request includes information and an address of the server in which the master portable communication device is registered; establishing a communication link with the master portable communication device; and receiving content based on the information provided in the request; and transmitting the content to the master portable communication device through the communication link.

Another aspect of the invention relates to the information being encrypted.

Another aspect of the invention relates to the address being an Internet Protocol address of the server.

Another aspect of the invention relates the communication link being a wireless local area network interface that is compatible with at least one of a Bluetooth compatible interface or a WiFi compatible interface.

One aspect of the invention relates to a portable communication device comprising: a processor; a user input device coupled to the processor for receiving a user input; a wireless wide area network adapter and a wireless local area network adapter coupled to the processor; a memory coupled to the processor, wherein the memory includes a bandwidth share application, wherein upon receipt of a predetermined user input the bandwidth share application causes: a first request for content stored remotely on a wide area network to be transmitted through the wireless wide area network interface to a server and also transmitting a second request for access to available bandwidth through the wireless local area network interface to one or more electronic equipment, wherein the second request includes information and an address of the server in which the master portable communication device is registered; establishing a communication link between the one or more electronic equipment that is able to provide additional bandwidth; and receiving at least a portion of the content from the server through the wide area network adapter and from the one or more electronic equipment through wireless local area network interface.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

It should be emphasized that the term “comprise/comprising” when used in this specification is taken to specify the presence of stated features, integers, steps or components but does not preclude the presence or addition of one or more other features, integers, steps, components or groups thereof.”

The term “electronic equipment” includes portable radio communication equipment. The term “portable radio communication equipment”, which herein after is referred to as a mobile radio terminal, includes all equipment such as mobile telephones, pagers, communicators, i.e., electronic organizers, personal digital assistants (PDA's), portable communication apparatus, smart phones or the like.

### BRIEF DESCRIPTION OF THE DRAWINGS

The foregoing and other embodiments of the invention are hereinafter discussed with reference to the drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIGS. 1 and 2 are exemplary block diagrams illustrating an exemplary portable communication device in accordance with aspects of the present invention.

FIG. 3 is an exemplary system in accordance with aspects of the present invention.

FIGS. 4 and 6 are flow charts illustrating exemplary methods in accordance with aspects of the present invention.

### DETAILED DESCRIPTION OF EMBODIMENTS

The present invention is directed to a method and system for a plurality of electronic equipment located within a short range communication zone to share bandwidth with each other. In one aspect of the invention, an electronic equipment (a requesting electronic equipment) transmits a request for content over a cellular telephone network (e.g., 3G, GPRS, etc.). In addition, the electronic equipment communicates with other electronic equipment through a wireless local area network (WLAN) interface (e.g., Bluetooth, 802.11, etc.) to determine if the other electronic equipment are available to share bandwidth with the requesting electronic equipment.

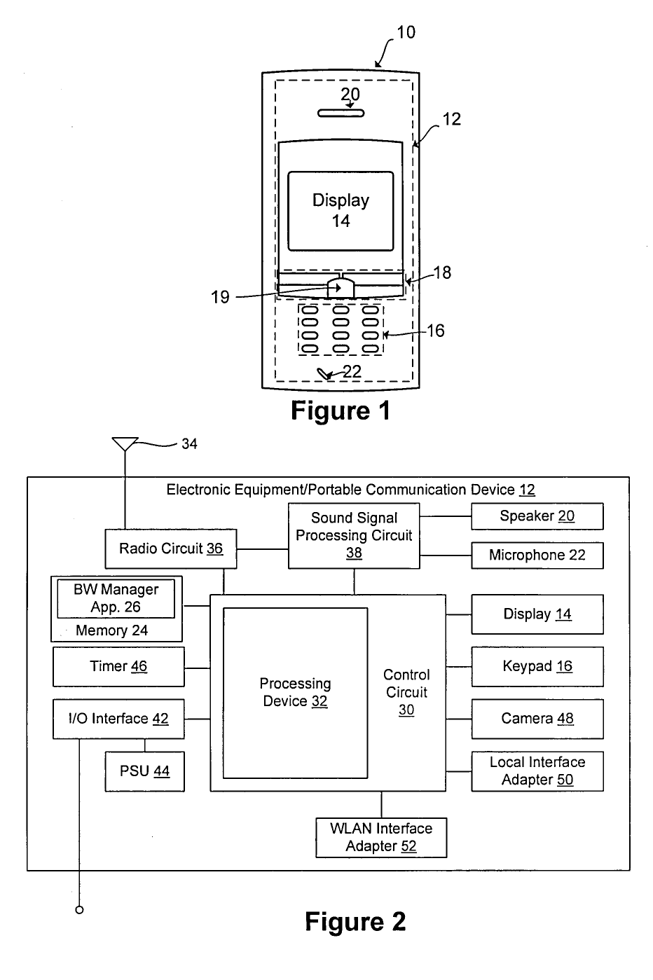

Referring to FIG. 1, an electronic equipment 10 is shown in accordance with aspects of the present invention. The electronic equipment 10 in the exemplary embodiment is a portable communication device and will be referred to as the portable communication device 10. One of ordinary skill in the art will readily appreciate that an electronic equipment may be any device that is capable of establishing a communication link with another device. Such devices include, for example, mobile telephones, computers, personal digital assistants, routers, modems, etc.

The portable communication device 10 is shown as having a “brick” or “block” design type housing, but it will be appreciated that other type housings, such as clamshell housing or a slide-type housing, may be utilized without departing from the scope of the invention.

As illustrated in FIG. 1, the portable communication device 10 may include a user interface 12 (identified by dashed lines) that enables the user to easily and efficiently perform one or more communication tasks (e.g., surf the Internet, download Internet content, send an E-mail, display an E-mail, receive an E-mail, identify a contact, select a contact, make a telephone call, receive a telephone call, etc). The user interface 12 of the portable communication device 10 generally includes one or more of the following components: a display 14, an alphanumeric keypad 16, function keys 18, a navigation tool 19, a speaker 20, and a microphone 22.

The portable communication device 10 includes a display 14. The display 14 displays information to a user such as operating state, time, telephone numbers, contact information, various navigational menus, status of one or more functions, etc., which enable the user to utilize the various features of the portable communication device 10. The display 14 may also be used to visually display content accessible by the portable communication device 10. The displayed content may include Internet content, E-mail messages, audio and/or video presentations stored locally in memory 24 (FIG. 2) of the portable communication device 10 and/or stored remotely from the portable communication device 10 (e.g., on a remote storage device, a mail server, remote personal computer, etc.). Such presentations may be derived, for example, from multimedia files received through E-mail messages, including audio and/or video files, from a received mobile radio and/or television signal, etc. The audio component may be broadcast to the user with a speaker 20 of the portable communication device 10. Alternatively, the audio component may be broadcast to the user though a headset speaker (not shown).

The portable communication device 10 further includes a keypad 16 that provides for a variety of user input operations. For example, the keypad 16 may include alphanumeric keys for allowing entry of alphanumeric information such as E-mail addresses, distribution lists, telephone numbers, phone lists, contact information, notes, etc. In addition, the keypad 16 typically may include special function keys such as a “call send” key for transmitting an E-mail, initiating or answering a call, and a “call end” key for ending, or “hanging up” a call. Special function keys may also include menu navigation keys, for example, for navigating through a menu displayed on the display 14 to select different telephone functions, profiles, settings, etc., as is conventional. Other keys associated with the portable communication device 10 may include a volume key, audio mute key, an on/off power key, a web browser launch key, an E-mail application launch key, a camera key, etc. Keys or key-like functionality may also be embodied as a touch screen associated with the display 14.

The portable communication device 10 includes conventional call circuitry that enables the portable communication device 10 to establish a call, transmit and/or receive E-mail messages, and/or exchange signals with a called/calling device, typically another mobile telephone or landline telephone. However, the called/calling device need not be another telephone, but may be some other device such as an Internet web server, E-mail server, content providing server, computer, etc.

Referring to FIG. 2, a functional block diagram of the portable communication device 10 is illustrated. The portable communication device 10 includes a primary control circuit 30 that is configured to carry out overall control of the functions and operations of the portable communication device 10. The control circuit 30 may include a processing device 32, such as a CPU, microcontroller or microprocessor. The processing device 32 executes code stored in a memory (not shown) within the control circuit 30 and/or in a separate memory, such as memory 24, in order to carry out operation of the portable communication device 10. The control circuit 30 is generally operative to operate in a first mode to when no electronic equipment are available to share bandwidth. In addition, the control circuit 30 is operative in a second mode when one or more electronic equipment are available to share bandwidth.

The memory 24 may be, for example, a buffer, a flash memory, a hard drive, a removable media, a volatile memory and/or a non-volatile memory. In addition, the processing device 32 executes code to carry out various functions of the portable communication device 10. The memory may include a bandwidth manager application 26 to manage bandwidth utilized by the portable communication device 10.

Continuing to refer to FIGS. 1 and 2, the portable communication device 10 includes an antenna 34 coupled to a radio circuit 36. The radio circuit 36 includes a radio frequency transmitter and receiver for transmitting and receiving signals via the antenna 34, as is conventional. The portable communication device 10 generally utilizes the radio circuit 36 and antenna 34 for voice and/or data communications (e.g., E-mail, Internet, etc.) over a cellular telephone network. The portable communication device 10 further includes a sound signal processing circuit 38 for processing the audio signal transmitted by/received from the radio circuit 36. Coupled to the sound processing circuit 38 are the speaker 20 and a microphone 22, which enable a user to listen and speak via the portable communication device 10 as is conventional. The radio circuit 36 and sound processing circuit 38 are each coupled to the control circuit 30 so as to carry out overall operation.

The portable communication device 10 also includes the aforementioned display 14 and keypad 16 coupled to the control circuit 30. The portable communication device 10 further includes an I/O interface 42. The I/O interface 42 may be in the form of typical mobile telephone I/O interfaces, such as a multi-element connector at the base of the portable communication device 10. As is typical, the I/O interface 42 may be used to couple the portable communication device 10 to a battery charger to charge a power supply unit (PSU) 44 within the portable communication device 10. In addition, or in the alternative, the I/O interface 42 may serve to connect the portable communication device 10 to a wired personal hands-free adaptor, to a personal computer or other device via a data cable, etc. The portable communication device 10 may also include a timer 46 for carrying out timing functions. Such functions may include timing the durations of calls, generating the content of time and date stamps, etc.

The portable communication device 10 may include various built-in accessories, such as a camera 48 for taking digital pictures. Image files corresponding to the pictures may be stored in the memory 24. In one embodiment, the portable communication device 10 also may include a position data receiver (not shown), such as a global positioning satellite (GPS) receiver, Galileo satellite system receiver or the like.

To establish wireless communication with other locally positioned devices, such as a wireless headset, electronic equipment, another portable communication device (e.g., mobile telephone), a computer, etc., the portable communication device 10 may include a local wireless interface adapter 50, such as a Bluetooth adaptor. In addition, to establishing wireless communication with other locally positioned devices, such as a wireless local area network (WLAN), wireless access point and the like, portable communication devices, computers, etc., the portable communication device 10 may further include a wireless local area network interface adapter 52. Preferably, the WLAN adapter 52 is compatible with one or more IEEE 802.11 protocols (e.g., 802.11(a), 802.11(b) and/or 802.11(g), etc.) and allows the portable communication device 10 to acquire a unique address (e.g., IP address) on the WLAN and communicate with one or more devices on the WLAN, assuming the user has the appropriate privileges and/or has been properly authenticated.

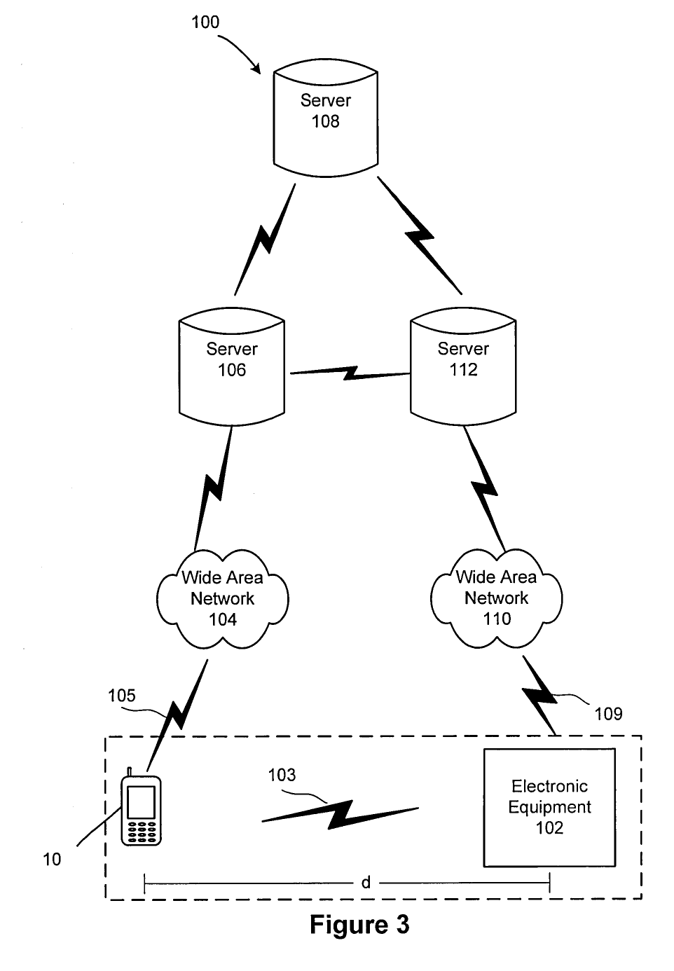

Referring to FIG. 3, an exemplary system 100 in accordance with aspects of the present invention is illustrated. The system 100 includes a master portable communication device (e.g., a device that issues a request for bandwidth) 10 and one or more other electronic equipment 102. Suitable electronic equipment 102 may include, for example, a portable communication device, a mobile telephone, a computer, a laptop, etc. Generally, the master portable communication device 10 communicates through a wide-area communication network 104 to a server 106 through a communication link 105. Communication through the communication link 105 between the device 10 and the wide-area communication network 104 may include a transmission medium in the form of a communications tower, a wireless access point, a satellite, etc. Portions of the network may include wireless and/or wired transmission pathways. The server 106 generally manages calls and/or data (e.g., Internet communications, E-mails, etc.) placed by and/or destined to the portable communication device 10, transmits content (e.g., image files, audio files, video files, etc.) to and/or from the portable communication device 10 and carrying out any other support functions.

The server 106 is commonly referred to as a proxy server. A proxy server generally is a dedicated server that acts as an intermediary between a portable communication device and the Internet so that the network operator can ensure security, administrative control, and caching service. A proxy server is associated with or part of a gateway server that separates the network operator's network from the outside network and a firewall server that protects the network from outside intrusion. The server 106 may also communicate with one or more remote servers 108 to receive content destined to and/or transmitted from the portable communication device 10 and/or other proxy servers to facilitate communication with other devices. One of ordinary skill in the art will readily appreciate that the server 106 may include public/private encryption keys to maintain secure authorized communications.

As shown in FIG. 3, electronic equipment 102 may also communicate through one or more wide-area communication networks, shown collectively as 110 to one or more servers 112 through the communication link 109. Communication through the communication link 109 between the electronic equipment 102 and the wide-area communication network 110 may include a transmission medium in the form of a communications tower, a wireless access point, a satellite, etc, as discussed above in conjunction with wide area communications network 104. Portions of the network 110 may include wireless and/or wired transmission pathways. The one or more servers 112 are commonly referred to as proxy severs, which manage calls and/or data (e.g., Internet communications, E-mails, etc.) placed by and/or destined to the electronic equipment 102, as explained above. One of ordinary skill in the art will readily appreciate that the each electronic equipment 102 may communicate with a separate proxy server to provide network authentication, security, administrative control and caching service. The server 112 may also communicate with one or more remote servers 108 to receive content destined to and/or transmitted from the portable communication device 10. Although the server 108 is shown as a single entity, one of ordinary skill in the art will readily appreciate that server 108 may include one or more remote servers that store information for viewing and/or rendering on mobile communication devices and other electronic equipment. Additionally, servers 106 and 112 may communicate with each other directly or through intermediaries, as desired to facilitate communication between one or more communication networks.

The portable communication device 10 and at least one of the electronic equipment 102 include a wireless local area network interface that allows the portable communication device 10 to communicate directly with the at least one or more electronic equipment 102. One of ordinary skill in the art will readily appreciate that a wired local area network interface and/or a combined wired and wireless interface may be used in accordance with aspects of the present invention. A suitable wireless local area network interface includes Bluetooth-compatible, 802.11-compatible interfaces, etc.

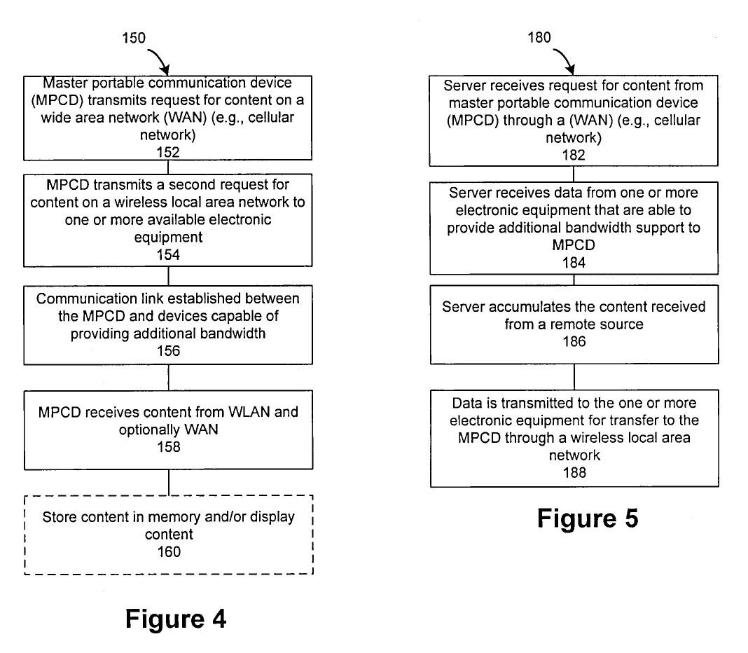

Referring to FIG. 4, an exemplary method 150 for sharing bandwidth between a master portable communication device (i.e., a portable communication device that issues a request for service) and electronic equipment in accordance with aspects of the present invention is illustrated. At block 152, a master portable communication device 10 transmits a first request for content stored remotely on a wide area network. As used herein “master portable communication device” means the device issuing a request. The request is transmitted through a wireless wide area network interface associated with the master portable communication device to a server 106.

At block 154, the master portable communication device also transmits a second request for access to available bandwidth to one or more electronic equipment. The request is generally transmitted through a wireless local area network interface of the master portable communication device 10 and received by a wireless local area network interface associated with the one or more electronic equipment within effective communication range of the master portable communication 10. The set of set of electronic equipment connected using a local area network interface may also be referred to as “peers”.

The second request includes information and an address (e.g., an Internet Protocol address) of the server in which the master portable communication device is registered. As used herein, the term “information” should be interpreted broadly and may include such items as: a data record containing information on which server may used to access in a request, as well as, identification of content desired (e.g., a uniform resource locator), the address of the proxy server for the master portable communication device 10. In one embodiment, it is preferable that all or a portion of the information be encrypted. For example, the information is encrypted except for the proxy address and the identification of the master portable communication device. Each electronic equipment (or peer) determines if is able to assist with the request. Those electronic equipment (or peers) that are able to comply, transmit the information to the server of the master portable communication device 10.

At block 156, a communication link is established between the one or more electronic equipment (or peers) 102 that are able to provide additional bandwidth for the master portable communication device 10. The communication link is generally a wireless local area network communication link that utilizes a Bluetooth-compatible protocol and/or a 802.11-compatible protocol (e.g., WiFi, WiMax, 802.11(a), 802.11(b), etc.). Optionally, the communication link may be periodically updated to determine if the one or more electronic equipment that previously established a communication link are within communication range of the master portable communication device.

At block 158, the master portable communication device 10 receives at least a portion of the content (e.g., multimedia content, Internet content, etc.) from the one or more electronic equipment 102 through the communication link. The master portable communication device 10 may also receive portions of the content directly from the server 106. In such case, the portions of content received from the one or more electronic equipment and the wide area network are combined and the combined contents are stored in memory. One of ordinary skill in the art will readily appreciate that it may be desirable to receive all information from the one or more electronic equipment, in order to allow the user to use his or her bandwidth for other purposes.

Given the portable nature of electronic equipment, one of ordinary skill in the art will readily appreciate that the master portable communication device 10 should periodically and/or at predefined times determine the status of communication links with other electronic equipment. If an electronic equipment becomes unavailable, the server 106 may update its list of participating slaves (e.g., participating electronic equipment) to stop sending requests and/or information to the electronic equipment that is no longer available. In addition, the list of electronic equipment may also increase. For example, during the update process, if additional devices have moved into the effective range of the master portable communication device and the devices are able to assist, these devices may be identified in the server 106.

Routing of information between the devices may be dynamic. For example, routing may be based on which device is providing a higher signal to noise ratio; which device has the strongest signal strength; which device has the highest nominal transmission rate; which device has the highest measured transmission rate, etc.

The master portable communication device and/or the server 106 may determine that information has been lost (e.g., not transmitted in a timely manner (timed out)) and re-request the information from the server 106.

Optionally, at block 160, at least a portion of the received content is stored in a memory 24 of the master portable communication device 10 and/or displayed to the user.

Another exemplary method 180 for a server to deliver content acquired from one or more electronic equipment to a master portable communication device 10 is illustrated in FIG. 5. At block 182, a server 106 receives a request for content from a master portable communication device 10 through a wide area network. At block 184, the server 106 receives data from one or more electronic equipment that are able to assist in downloading the content requested by the master portable communication device. At block 186, the server 106 accumulates the data received from the remote source. At block 188, at least a portion of the data is transmitted from the server 106 to the one or more electronic equipment for transmission to the master portable communication device through a wireless local area network interface. A suitable network interface is generally a wireless local area network communication link that utilizes a Bluetooth-compatible protocol and/or a 802.11-compatible protocol (e.g., WiFi, WiMax, 802.11(a), 802.11(b), etc.). Optionally, the suitable network interface may be periodically updated to determine if the one or more electronic equipment that previously established a communication link are within communication range of the master portable communication device.

The data may be transmitted to the master portable communication device after the requested content is accumulated. Alternatively, data may be transmitted to the master portable communication device after at least one portion of the requested content is accumulated.

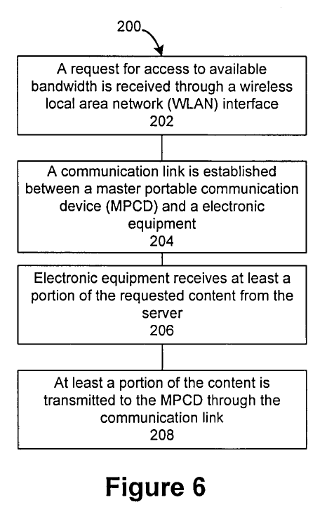

An exemplary method 200 for sharing bandwidth between a master portable communication device and electronic equipment is illustrated in FIG. 6. At block 202, a request for access to available bandwidth is received through a wireless local area network interface from a master portable communication device by an electronic equipment. The request includes information and an address of the server in which the master portable communication device is registered. The request may be at least partially encrypted to protect the privacy of the user that requested the content. At block 204, a communication link is established between the master portable communication device 10 and the electronic equipment. At block 206, the electronic equipment receives at least a portion of the requested content from the server 106 that is registered with the master portable communication device 10. At block 208, at least a portion of content is transmitted to the master portable communication device through the communication link.

The above methods assume that each of the electronic and/or master portable communication device 10 are within an operative distance “d” from each other (as shown in FIG. 3). The distance “d” is within communication range of the portable communication device 10. One of ordinary skill in the art will readily appreciate that the operative distance “d” will vary depending on, among other things, the modality used for communication. For example, the operative range for Bluetooth communication is less than 20 meters and the operative range for 802-11 communication is much farther.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

What is claimed is:

1. A method for sharing bandwidth between a master portable communication device and electronic equipment, the method comprising:
transmitting a first request for content stored remotely on a wide area network from a master portable communication device through a wireless wide area network interface to a server and transmitting a second request for access to available bandwidth through a wireless local area network interface of the master portable communication device to one or more electronic equipment, wherein the second request includes information and an address of the server in which the master portable communication device is registered;
establishing a communication link between the one or more electronic equipment that is able to provide additional bandwidth for the master portable communication device; and
receiving at least a portion of the content at the master portable communication device from the one or more electronic equipment through the communication link established between the one or more electronic equipment and the master portable communication device.

2. The method of claim 1, wherein the information transmitted to the one or more electronic devices from the master portable communication device is encrypted.

3. The method of claim 1, wherein the server is a proxy server.

4. The method of claim 1 further including storing at least a portion of the received content in a memory of the master portable communication device.

5. The method of claim 1 further including displaying at least a portion of the received content on display of the master portable communication device.

6. The method of claim 1 further including periodically updating the communication link between the one or more electronic equipment and the portable communication device to determine if the one or more electronic equipment are within communication range of the master portable communication device.

7. The method of clam 1, wherein the address is an Internet Protocol address of the server.

8. The method of claim 1, wherein the wireless local area network interface is a Bluetooth compatible interface.

9. The method of claim 1, wherein the wireless local area network interface is a WiFi compatible interface.

10. The method of claim 1 further including receiving a second portion of the content from the server through the wireless wide area network.

11. The method of claim 10 further including combining the portions of content received from the one or more electronic equipment and the wide area network and storing the combined contents in memory.

12. A method for a server to deliver content acquired from multiple electronic equipment to a master portable communication device, the method comprising:
receiving a request for content from a master portable communication device through a wide area network;
receiving data from one or more electronic equipment that are able to assist in downloading the content requested by the master portable communication device;
accumulating data received from a remote source that stores the requested content; and
transmitting at least a portion of the data to the one or more electronic equipment for transmission to the master portable communication device, wherein the data relates to the requested content.

13. The method of claim 12, wherein the data is transmitted from the electronic equipment to the portable communication device through a wireless local area network interface.

14. The method of claim 13, wherein the wireless local area network interface is a Bluetooth compatible interface.

15. The method of claim 13, wherein the wireless local area network interface is a WiFi compatible interface.

16. The method of claim 12, wherein the at least a portion of data is transmitted to the master portable communication device after the requested content is accumulated.

17. The method of claim 12, wherein the at least a portion of data is transmitted to the master portable communication device after at least one portion of the requested content is accumulated.

18. A method for sharing bandwidth between a master portable communication device and electronic equipment, the method comprising:
receiving a request for access to available bandwidth through a wireless local area network interface from a master portable communication device, wherein the request includes information and an address of the server in which the master portable communication device is registered;
establishing a communication link with the master portable communication device; and
receiving content based on the information provided in the request
transmitting the content to the master portable communication device through the communication link.

19. The method of clam 18, wherein the information is encrypted.

20. The method of claim 18, wherein the address is an Internet Protocol address of the server.

21. The method of claim 8, wherein the communication link is wireless local area network interface that is compatible with at least one of a Bluetooth compatible interface or a WiFi compatible interface.

22. A portable communication device comprising:
a processor;
a user input device coupled to the processor for receiving a user input;
a wireless wide area network adapter and a wireless local area network adapter coupled to the processor;
a memory coupled to the processor, wherein the memory includes a bandwidth share application, wherein upon receipt of a predetermined user input the bandwidth share application causes:
a first request for content stored remotely on a wide area network to be transmitted through the wireless wide area network interface to a server and also transmitting a second request for access to available bandwidth through the wireless local area network interface to one or more electronic equipment, wherein the second request includes information and an address of the server in which the master portable communication device is registered; establishing a communication link between the one or more electronic equipment that is able to provide additional bandwidth; and receiving at least a portion of the content from the server through the wide area network adapter and from the one or more electronic equipment through wireless local area network interface.
